(19) United States
(12) Patent Application Publication
(10) Pub. No.: US 2026/0246159 A1
(43) Pub. Date: Aug. 20, 2026

(54) ANTENNA DEVICE

(71) Applicant: Mitsubishi Electric Corporation, Tokyo (JP)

(72) Inventors: Takashi UNO, Tokyo (JP); Takashi MARUYAMA, Tokyo (JP); Toru TAKAHASHI, Tokyo (JP)

(73) Assignee: Mitsubishi Electric Corporation, Tokyo (JP)

(21) Appl. No.: 19/646,045

(22) Filed: Apr. 13, 2026

Related U.S. Application Data
(63) Continuation of application No. PCT/JP2023/044751, filed on Dec. 14, 2023.

(51) Int. Cl. H01Q 21/06

(52) U.S. Cl. CPC H01Q 21/062

(57) ABSTRACT

An array antenna having element antennas regularly arrayed at element spacing along element array axes; and a dielectric that has holes arrayed at hole spacing which is 1/n (n is an integer equal to or greater than two) of the element spacing along hole array axes lying in the same direction as the element array axes, the dielectric being disposed to face the array antenna in a direction orthogonal to the element array axis, are included.

### CROSS REFERENCE TO RELATED APPLICATION

This application is a Continuation of PCT International Application No. PCT/JP2023/044751, filed on December 14, 2023, which is hereby expressly incorporated by reference into the present application.

### TECHNICAL FIELD

The present disclosure relates to an antenna device including an array antenna.

### BACKGROUND ART

There is a conventionally known tightly coupled dipole array antenna (Tightly Coupled Dipole Array) as an antenna device including a low-profile, broadband array antenna (e.g. see Patent Literature 1).

A tightly coupled dipole array antenna described in Patent Literature 1 includes a feed line, baluns, dipoles, and a matching layer. In addition, the baluns include open stubs and short stubs.

In the tightly coupled dipole array antenna, a high-frequency signal is supplied by the feed line, and the dipoles are differentially excited by the baluns. In addition, in the tightly coupled dipole array antenna, for broadband operation of the antenna, the matching layer is provided above the dipoles. In addition, in the tightly coupled dipole array antenna, typically, a dielectric with low relative permittivity is used as the matching layer.

### CITATION LIST

### PATENT LITERTURE

Patent Literature 1: U.S. Patent Application Publication No. 2014/0009356

### SUMMARY OF INVENTION

### TECHNICAL PROBLEM

In this manner, typically, a dielectric with low relative permittivity is used in a matching layer used for bandwidth broadening.

However, dielectrics with low relative permittivity are expensive and are difficult to obtain. Accordingly, an increase in manufacturing costs becomes a problem for an antenna device including a matching layer using such a dielectric with low relative permittivity.

In addition, the relative permittivity of the matching layer required for bandwidth broadening differs depending on the configuration of the antenna device. Accordingly, depending on the configuration of the antenna device, there is not a dielectric having desired relative permittivity, and bandwidth narrowing of the operating frequency becomes a problem, in some cases.

The present disclosure has been made to solve the problem described above, and an object thereof is to provide an antenna device whose bandwidth can be broadened at low cost compared to conventional techniques.

### SOLUTION TO PROBLEM

An antenna device according to the present disclosure includes: an array antenna having element antennas regularly arrayed at first spacing along first array axes; and a dielectric that has holes arrayed at second spacing which is 1/n (n is an integer equal to or greater than two) of the first spacing along second array axes lying in the same direction as the first array axes, the dielectric being disposed to face the array antenna in a direction orthogonal to the first array axes.

### ADVANTAGEOUS EFFECTS OF INVENTION

Since the present disclosure adopts the configuration described above, it is possible to broaden the bandwidth at low cost compared to conventional techniques.

### BRIEF DESCRIPTION OF DRAWINGS

FIG. 1 is a perspective view illustrating a configuration example of an antenna device according to a first embodiment.

FIG. 2 is a top view illustrating a configuration example of an array antenna in the first embodiment.

FIG. 3 is a top view illustrating a configuration example of a matching layer in the first embodiment.

FIG. 4 is a perspective view illustrating a configuration example of a unit cell in the antenna device according to the first embodiment.

FIG. 5 is a top view illustrating another configuration example of the matching layer in the first embodiment.

FIG. 6 is a top view illustrating another configuration example of the matching layer in the first embodiment.

FIG. 7 is a top view illustrating another configuration example of the matching layer in the first embodiment.

FIG. 8 is a perspective view illustrating a configuration example of a unit cell in an antenna device according to a second embodiment.

FIG. 9 is an exploded perspective view illustrating a configuration example of the unit cell in the antenna device according to the second embodiment.

FIG. 10 is a side view illustrating a configuration example of a first layer of a dielectric substrate in the second embodiment.

FIG. 11 is a side view illustrating a configuration example of a second layer of the dielectric substrate in the second embodiment.

FIG. 12 is a drawing for explaining advantageous effects of the antenna device according to the second embodiment, and is a perspective view illustrating an example of current distribution on dipoles in a case where a coupling conductor pattern is not provided on the dielectric substrate.

FIG. 13 is a drawing for explaining advantageous effects of the antenna device according to the second embodiment, and is a perspective view illustrating an example of current distribution on dipoles in a case where the coupling conductor pattern is provided on the dielectric substrate.

FIG. 14 is a perspective view illustrating a configuration example of a unit cell in an antenna device according to a third embodiment.

FIG. 15 is an exploded perspective view illustrating a configuration example of the unit cell in the antenna device according to the third embodiment.

FIG. 16 is a side view illustrating a configuration example of a first layer of a dielectric substrate in the third embodiment.

FIG. 17 is a side view illustrating a configuration example of a second layer of the dielectric substrate in the third embodiment.

FIG. 18 is a drawing for explaining advantageous effects of the antenna device according to the third embodiment, and is a side view illustrating an example of current distribution on a balun in a case where a short-circuit conductor pattern is not provided on the dielectric substrate.

FIG. 19 is a drawing for explaining advantageous effects of the antenna device according to the third embodiment, and is a drawing illustrating an example of current distribution on the balun in a case where the short-circuit conductor pattern is provided on the dielectric substrate.

FIG. 20 is a perspective view illustrating a configuration example of a unit cell in an antenna device according to a fourth embodiment.

FIG. 21 is an exploded perspective view illustrating a configuration example of the unit cell in the antenna device according to the fourth embodiment.

FIG. 22 is a side view illustrating a configuration example of a first layer of a dielectric substrate in the fourth embodiment.

FIG. 23 is a side view illustrating a configuration example of a second layer of the dielectric substrate in the fourth embodiment.

FIG. 24 is a drawing for explaining advantageous effects of the antenna device according to the fourth embodiment, and is a side view illustrating an example of current distribution in a case where a resistor is not provided on the dielectric substrate.

FIG. 25 is a drawing for explaining advantageous effects of the antenna device according to the fourth embodiment, and is a side view illustrating an example of current distribution in a case where the resistor is provided on the dielectric substrate.

FIG. 26 is a perspective view illustrating a configuration example of a unit cell in an antenna device according to a fifth embodiment.

FIG. 27 is an exploded perspective view illustrating a configuration example of the unit cell in the antenna device according to the fifth embodiment.

FIG. 28 is a side view illustrating a configuration example of a first layer of a dielectric substrate in the fifth embodiment.

FIG. 29 is a side view illustrating a configuration example of a second layer of the dielectric substrate in the fifth embodiment.

FIG. 30 is a perspective view illustrating a configuration example of a unit cell in an antenna device according to a sixth embodiment.

FIG. 31 is an exploded perspective view illustrating a configuration example of the unit cell in the antenna device according to the sixth embodiment.

FIG. 32 is a drawing for explaining advantageous effects of the antenna device according to the sixth embodiment, and is a drawing illustrating an example of a reflection coefficient analysis value of a horizontal polarization element.

FIG. 33 is a drawing for explaining advantageous effects of the antenna device according to the sixth embodiment, and is a drawing illustrating an example of a reflection coefficient analysis value of a vertical polarization element.

### DESCRIPTION OF EMBODIMENTS

Hereinbelow, embodiments are explained in detail with reference to the drawings.

First Embodiment.

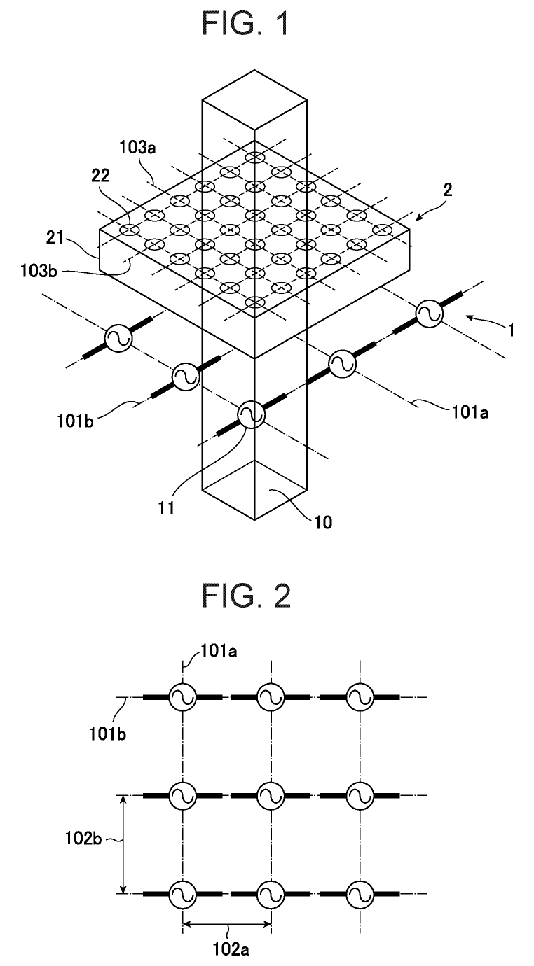

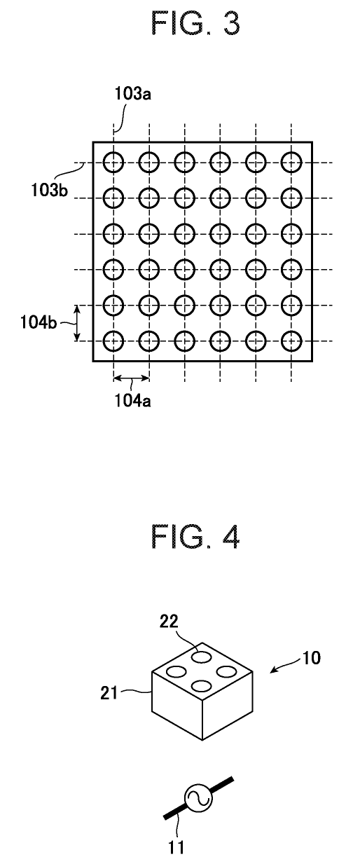

FIG. 1 is a perspective view illustrating a configuration example of an antenna device according to a first embodiment. FIG. 2 is a top view illustrating a configuration example of an array antenna 1 in the first embodiment. FIG. 3 is a top view illustrating a configuration example of a matching layer 2 in the first embodiment.

As illustrated in FIGS. 1 to 3, the antenna device includes the array antenna 1 and the matching layer 2.

As illustrated in FIG. 1 and FIG. 2, the array antenna 1 has a plurality of element antennas 11.

The element antennas 11 are arrayed regularly at predetermined element spacing (first spacing) 102a and 102b along element array axes (first array axes) 101a and 101b.

FIG. 1 illustrates a case where the array of the element antennas 11 is a square array. That is, in FIG. 1, the element array axes 101a and the element array axes 101b are arranged to be orthogonal to each other.

The matching layer 2 is arranged to face the array antenna 1 in a direction orthogonal (including substantially orthogonal) to the element array axes 101a and 101b. In FIG. 1, the matching layer 2 is arranged above the array antenna 1.

As illustrated in FIG. 1 and FIG. 3, the matching layer 2 has configuration in which a plurality of holes 22 are provided through a dielectric 21.

The holes 22 provided through the dielectric 21 are arrayed regularly at predetermined hole spacing (second spacing) 104a and 104b along hole array axes (second array axes) 103a and 103b. The hole array axes 103a and 103b are array axes lying in the same (including substantially the same) directions as the element array axes 101a and 101b. The hole spacing 104a and 104b is 1/n (n is an integer equal to or greater than two) of the element spacing 102a and 102b.

FIG. 1 illustrates a case where the array of the holes 22 is a square array. That is, in FIG. 1, the hole array axes 103a and the hole array axes 103b are arranged to be orthogonal to each other. In addition, FIG. 1 illustrates a case where the shape of the holes 22 is circular. In addition, FIG. 1 illustrates a case where the hole spacing 104a and 104b is 1/2 of the element spacing 102a and 102b.

Note that typically an array antenna includes a large number of arrayed unit cells, which are the minimum units.

In the antenna device according to the first embodiment, each unit cell 10 is one illustrated in FIG. 1 and FIG. 4 for example.

Next, advantageous effects of the antenna device according to the first embodiment are explained.

Assuming that the characteristic impedance in free space is defined as η, the characteristic impedance in the matching layer is inversely proportional to √(εr). Note that εr represents the relative permittivity of the matching layer. Because of this, by adjusting the relative permittivity or thickness of the matching layer 2, the input impedance as seen from the matching layer toward free space can be controlled. By adjusting the input impedance to a value suited for bandwidth broadening of the array antenna, bandwidth broadening of the antenna device is possible. In addition, even in a case the excitation phase of the element antennas is controlled, and beam scanning is performed in a wide angular direction, matching design can be performed and the coverage of the array antenna can be expanded by adjusting the input impedance as seen from the matching layer toward free space.

Note that the adjustment of the input impedance uses the relative permittivity and thickness of the matching layer as parameters. The relative permittivity and thickness of the matching layer required for bandwidth broadening differs depending on the configuration of the antenna device, and typically low relative permittivity is required.

As the matching layer, conventionally, a dielectric with low relative permittivity has been used as described in Patent Literature 1. Since such a dielectric with low relative permittivity is expensive and difficult to obtain, an increase in manufacturing costs of an antenna device is a problem.

In contrast to this, it is possible to lower the effective relative permittivity of the matching layer 2 in the antenna device according to the first embodiment by using, as the matching layer 2, the dielectric 21 provided with the plurality of holes 22. By using such a dielectric 21 having the holes 22, it is possible to implement the matching layer 2 with low relative permittivity in the antenna device according to the first embodiment even if a dielectric with relatively high relative permittivity typically used as the dielectric 21 is used. As a result, it is possible to improve manufacturing costs of the antenna device according to the first embodiment compared to conventional techniques.

In addition, depending on the configuration of the antenna device, there is not a dielectric having desired relative permittivity required for bandwidth broadening, and bandwidth narrowing of the operating frequency becomes a problem, in some cases.

In contrast to this, it is possible to control the effective permittivity of the matching layer 2 in the antenna device according to the first embodiment by adjusting the shape of the holes 22 provided through the dielectric 21. Thereby, it is possible to implement the matching layer 2 having effective permittivity suited for bandwidth broadening in the antenna device according to the first embodiment. As a result, it is possible to broaden the bandwidth of the antenna device according to the first embodiment compared to conventional techniques.

In addition, if the hole spacing 104a and 104b and the element spacing 102a and 102b are the same, that is, if n = 1, the size of the holes 22 needs to be increased in order to achieve the matching layer 2 with low effective permittivity. In this case, there is a possibility that the shape of the holes 22 becomes approximately the same as the wavelength. Then, if the shape of the holes 22 becomes approximately the same as the wavelength, frequency characteristics arise in the effective permittivity of the matching layer 2, and the bandwidth of the antenna device is narrowed, in some cases.

In view of this, in the antenna device according to the first embodiment, the hole spacing 104a and 104b is 1/n (where n is an integer equal to or greater than two) of the element spacing 102a and 102b. Thereby, in the antenna device according to the first embodiment, it is possible to make the shape of the holes 22 equal to or smaller than the wavelength and to lower the frequency characteristics of the effective permittivity of the matching layer 2.

Note that FIG. 3 illustrates a case where the shape of the holes 22 provided through the matching layer 2 is circular, and the array of the holes 22 is a square array. However, the shape and array of the holes 22 are not limited to these.

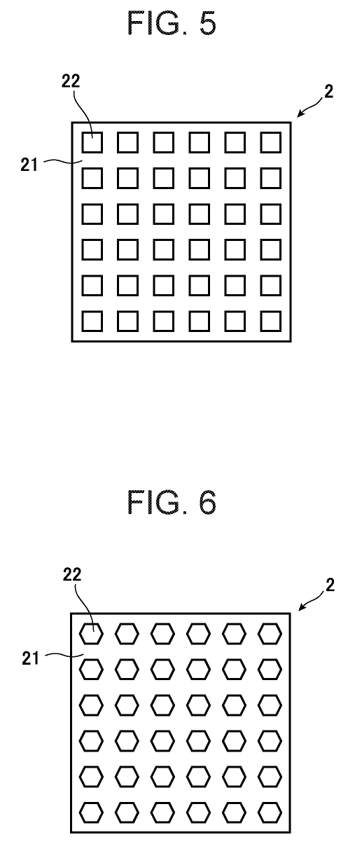

For example, FIG. 5 illustrates a case where the shape of the holes 22 provided through the matching layer 2 is rectangular. In addition, for example, FIG. 6 illustrates a case where the shape of the holes 22 provided through the matching layer 2 is hexagonal. Even in a case where the shape of the holes 22 is not circular in this manner, advantageous effects similar to those described above can be achieved.

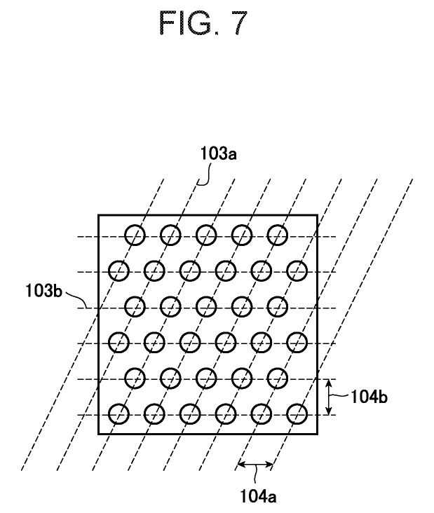

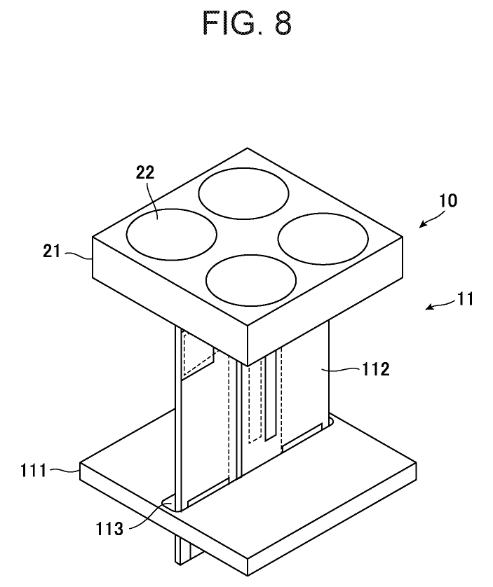

In addition, for example, FIG. 7 illustrates a case where the array of the holes 22 provided through the matching layer 2 is a triangular array. Even in a case where the array of the holes 22 is not a square array in this manner, advantageous effects similar to those described above can be achieved.

As described above, according to the first embodiment, the antenna device includes: the array antenna 1 having the element antennas 11 regularly arrayed at the element spacing 102a and 102b along the element array axes 101a and 101b; and the dielectric 21 that has the holes 22 arrayed at the hole spacing 104a and 104b which is 1/n (n is an integer equal to or greater than two) of the element spacing 102a and 102b along the hole array axes 103a and 103b lying in the same direction as the element array axes 101a and 101b, the dielectric 21 being disposed to face the array antenna 1 in a direction orthogonal to the element array axes 101a and 101b. Thereby, it is possible to broaden the bandwidth of the antenna device according to the first embodiment at low cost compared to conventional techniques.

That is, the dielectric 21 through which the plurality of holes 22 are provided is used as the matching layer 2 in the antenna device according to the first embodiment. Thereby, it is possible to lower the effective relative permittivity of the matching layer 2 in the antenna device according to the first embodiment. Accordingly, even if a typically-used dielectric with relatively high relative permittivity is used as the dielectric 21 in the antenna device according to the first embodiment, it is possible to implement the matching layer 2 with low relative permittivity and to improve manufacturing costs compared to conventional techniques.

In addition, it is possible to control the effective permittivity of the matching layer 2 in the antenna device according to the first embodiment by adjusting the shape of the holes 22 provided through the dielectric 21. Accordingly, it is possible to implement the matching layer 2 suited for bandwidth broadening and to broaden the bandwidth of the antenna device according to the first embodiment compared to conventional techniques.

In addition, in the antenna device according to the first embodiment, the hole spacing 104a and 104b is 1/n (n is an integer equal to or greater than two) of the element spacing 102a and 102b. Thereby, in the antenna device according to the first embodiment, it is possible to make the shape of the holes 22 equal to or smaller than the wavelength and to lower the frequency characteristics of the effective permittivity of the matching layer 2.

Second Embodiment.

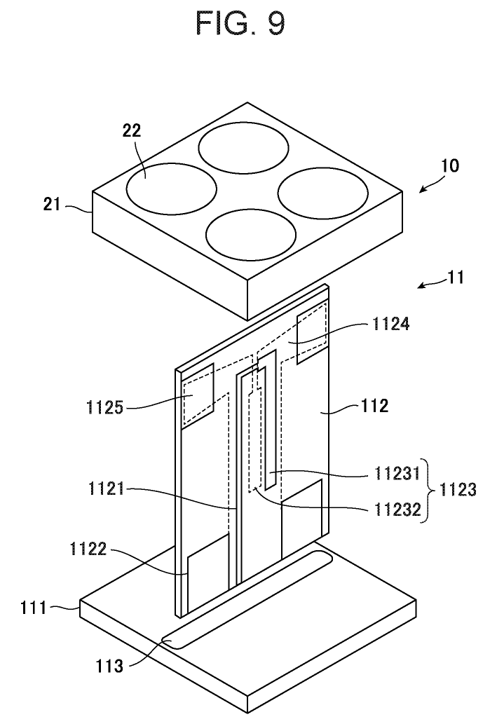

FIG. 8 is a perspective view illustrating a configuration example of a unit cell 10 in an antenna device according to a second embodiment. FIG. 9 is an exploded perspective view illustrating a configuration example of the unit cell 10 in the antenna device according to the second embodiment.

In the antenna device according to the second embodiment, an example is shown in which tightly coupled dipoles are applied as element antennas 11 to the antenna device according to the first embodiment. Other configuration examples of the antenna device according to the second embodiment are similar to the configuration examples of the antenna device according to the first embodiment, the same reference signs are given to them, and explanation thereof is omitted.

As illustrated in FIG. 8 and FIG. 9, each element antenna 11 in the second embodiment has a metallic plate 111 and a dielectric substrate 112.

The metallic plate 111 is disposed along element array axes 101a and 101b. A slot 113 into which the dielectric substrate 112 can be inserted is formed through the metallic plate 111. In FIG. 8, the slot 113 is formed along the element array axis 101b.

The dielectric substrate 112 is inserted into the metallic plate 111 at the slot 113, and is disposed in a direction orthogonal (including substantially orthogonal) to the element array axes 101a and 101b (metallic plate 111). In FIG. 8, the dielectric substrate 112 is disposed along the element array axis 101b.

Next, a configuration example of the dielectric substrate 112 is explained.

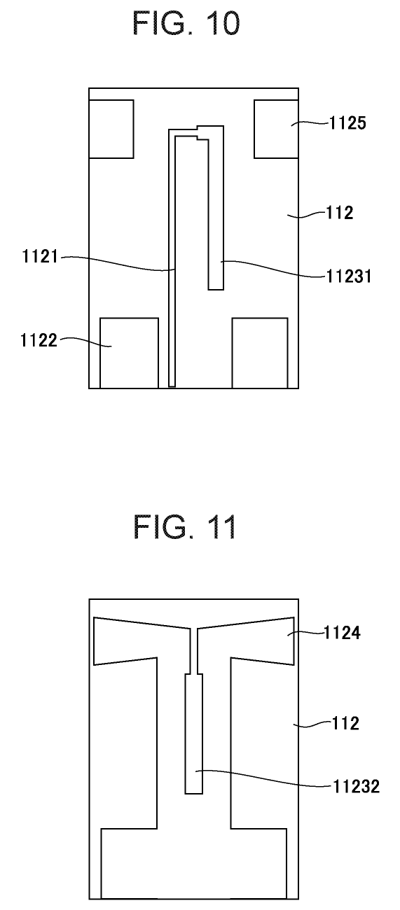

FIG. 10 is a side view illustrating a configuration example of a first layer of the dielectric substrate 112 in the second embodiment, and FIG. 11 is a side view illustrating a configuration example of a second layer of the dielectric substrate 112 in the second embodiment.

As illustrated in FIGS. 9 to 11, a feed line 1121, a ground 1122, a balun 1123, a dipole 1124, and a coupling conductor pattern 1125 are formed on the dielectric substrate 112. In addition, in FIGS. 9 to 11, the balun 1123 includes an open stub 11231 and a short stub 11232.

The feed line 1121 is a metallic conductor provided on the first surface of the dielectric substrate 112. The feed line 1121 is a line for supplying a high-frequency signal.

The ground 1122 is a metallic conductor provided on the first surface of the dielectric substrate 112.

The open stub 11231 is a metallic conductor provided on the first surface of the dielectric substrate 112. A first end of the open stub 11231 is connected to a first end of the feed line 1121.

The short stub 11232 is provided on the second surface of the dielectric substrate 112.

The dipole 1124 is a metallic conductor provided on the second surface of the dielectric substrate 112.

The coupling conductor pattern 1125 is a conductor provided at a position which is on the first surface of the dielectric substrate 112 and overlaps two adjacent dipoles 1124 (see FIG. 13).

In the dielectric substrate 112, a high-frequency signal is supplied by the feed line 1121, and the dipole 1124 is differentially excited by the balun 1123.

In addition, in the dielectric substrate 112, the coupling conductor pattern 1125 is formed to overlap adjacent dipoles 1124 with the dielectric substrate 112 interposed therebetween, in order to enhance the coupling between the dipoles 1124.

Next, advantageous effects of the antenna device according to the second embodiment are explained.

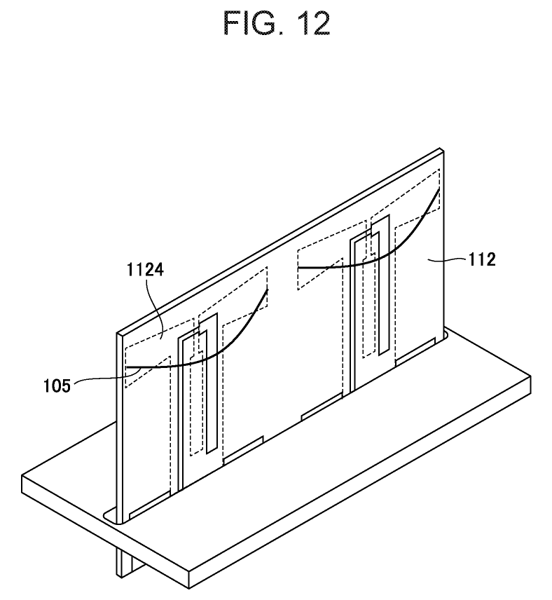

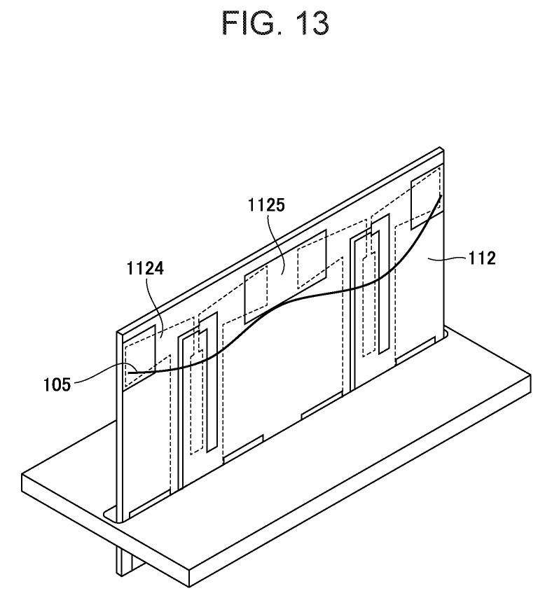

FIG. 12 is a perspective view illustrating an example of current distribution on the dipoles 1124 in a case where the coupling conductor pattern 1125 is not provided on the dielectric substrate 112. FIG. 13 is a perspective view illustrating an example of current distribution on the dipoles 1124 in a case where the coupling conductor pattern 1125 is provided on the dielectric substrate 112. It should be noted that a matching layer 2 is not illustrated in FIG. 12 and FIG. 13.

As illustrated in FIG. 12, in a case where the coupling conductor pattern 1125 is not provided on the dielectric substrate 112, the ends of the dipoles 1124 are electrically open. Accordingly, in this case, the values of current distribution 105 at the ends of the dipoles 1124 are low, and resonance occurs at a frequency where the dipole length becomes approximately 1/2 of the wavelength. As a result, the antenna device exhibits narrowband electrical characteristics.

In contrast to this, as illustrated in FIG. 13, in a case where the coupling conductor pattern 1125 is provided on the dielectric substrate 112, the adjacent dipoles 1124 are electromagnetically coupled by the coupling conductor pattern 1125, and the ends of the dipoles 1124 are electrically not open. Accordingly, in this case, the antenna functions as a broadband antenna that operates not only at the frequency where the dipole length becomes approximately 1/2 of the wavelength, but across a broad bandwidth.

Note that FIG. 9 illustrates a case where the balun 1123 includes the open stub 11231 and the short stub 11232. However, this is not the sole configuration example of the balun 1123.

For example, even when a taper balun or the like in which the shape of the feed line 1121 tapers is used as the balun 1123, the dipole 1124 can be differentially excited, and advantageous effects similar to those described above can be achieved.

As described above, according to the second embodiment, the element antenna 11 includes: the metallic plate 111 disposed along the element array axes 101a and 101b; and the dielectric substrate 112 that: has the dipole 1124 which is a metallic conductor on the first surface; is inserted into the metallic plate 111; and is disposed in a direction orthogonal to the element array axes 101a and 101b. In addition, the dielectric substrate 112 has the coupling conductor pattern 1125 which is a metallic conductor at a position which is on the second surface and overlaps the two adjacent dipoles 1124. Thereby, it is possible to further broaden the bandwidth of the antenna device according to the second embodiment, in addition to the advantageous effects of the first embodiment.

Third Embodiment.

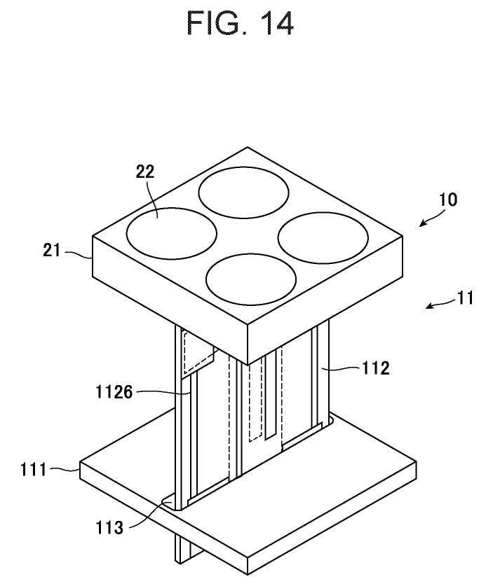

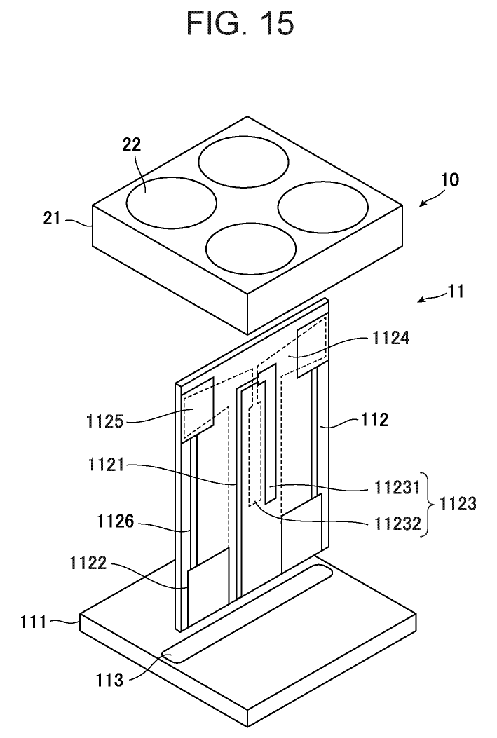

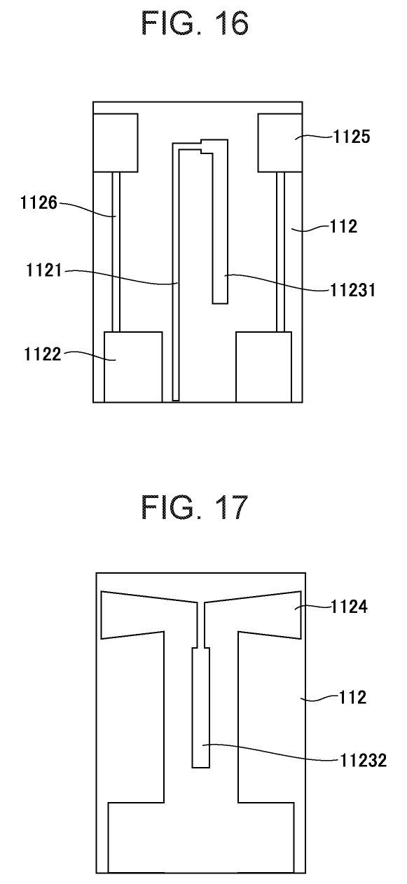

FIG. 14 is a perspective view illustrating a configuration example of a unit cell 10 in an antenna device according to a third embodiment. FIG. 15 is an exploded perspective view illustrating a configuration example of the unit cell 10 in the antenna device according to the third embodiment. In addition, FIG. 16 is a side view illustrating a configuration example of a first layer of a dielectric substrate 112 in the third embodiment, and FIG. 17 is a side view illustrating a configuration example of a second layer of the dielectric substrate 112 in the third embodiment.

The antenna device according to the third embodiment is obtained by forming a short-circuit conductor pattern 1126 on the dielectric substrate 112 in the antenna device according to the second embodiment. Other configuration examples of the antenna device according to the third embodiment are similar to the configuration examples of the antenna device according to the second embodiment, the same reference signs are given to them, and explanation thereof is omitted.

The short-circuit conductor pattern 1126 is a metallic conductor provided on the first surface of the dielectric substrate 112. The short-circuit conductor pattern 1126 has a first end connected to a coupling conductor pattern 1125 and a second end connected to a ground 1122.

Next, advantageous effects of the antenna device according to the third embodiment are explained.

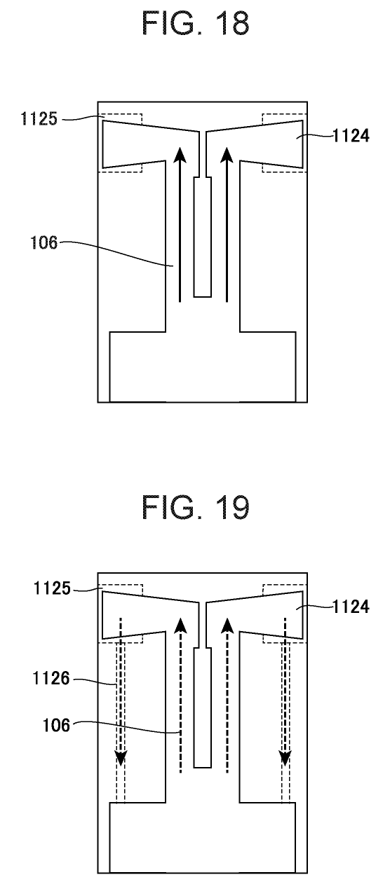

FIG. 18 is a side view illustrating an example of current distribution on a balun 1123 in a case where the short-circuit conductor pattern 1126 is not provided on the dielectric substrate 112. FIG. 19 is a side view illustrating an example of current distribution on the balun 1123 in a case where the short-circuit conductor pattern 1126 is provided on the dielectric substrate 112.

The balun 1123 is provided for differentially exciting a dipole 1124, and, as illustrated in FIG. 18 for example, not only differential mode current, but also common mode current 106 is partially generated in the balun 1123. The common mode current 106 resonates at a frequency where the spacing of the balun 1123 becomes approximately 1/2 of the wavelength, and, due to this common mode resonance, the dipole 1124 is no longer differentially excited. As a result, the electrical characteristics of the antenna device deteriorate significantly.

Note that it is known that connecting a dipole and a ground using a short-circuit conductor pattern is effective as a method for reducing the influence of the common mode resonance. However, connecting a short-circuit conductor pattern to a dipole causes variations in the electrical characteristics of the dipole.

In view of this, in the antenna device according to the third embodiment, the coupling conductor pattern 1125 and the ground 1122 are connected using the short-circuit conductor pattern 1126. Thereby, current flows through the short-circuit conductor pattern 1126 as illustrated in FIG. 19 for example. Then, the current that flows through the short-circuit conductor pattern 1126 cancels the common mode current 106 and reduces the influence of the common mode resonance. As a result, it is possible to prevent deterioration of the electrical characteristics of the antenna device according to the third embodiment. In addition, it is also possible to prevent variations in the electrical characteristics of the dipole 1124 in the antenna device according to the third embodiment.

As described above, according to the third embodiment, the dielectric substrate 112 has, on a second surface, the short-circuit conductor pattern 1126 which is a metallic conductor having the first end connected to the coupling conductor pattern 1125 and the second end connected to the ground 1122. Thereby, it is possible to reduce the influence of the common mode resonance and to further broaden the bandwidth of the antenna device according to the third embodiment, in addition to the advantageous effects of the second embodiment.

Fourth Embodiment.

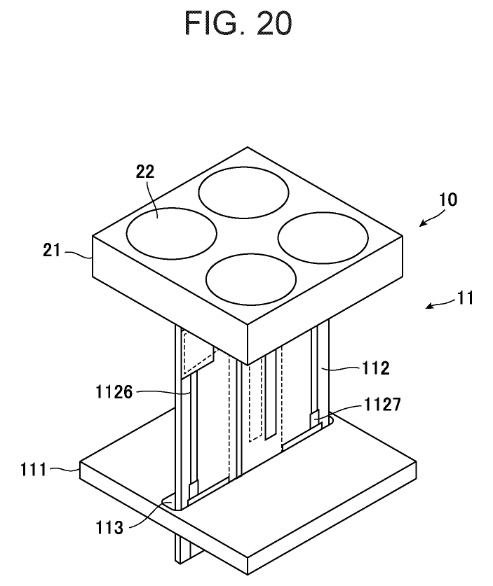

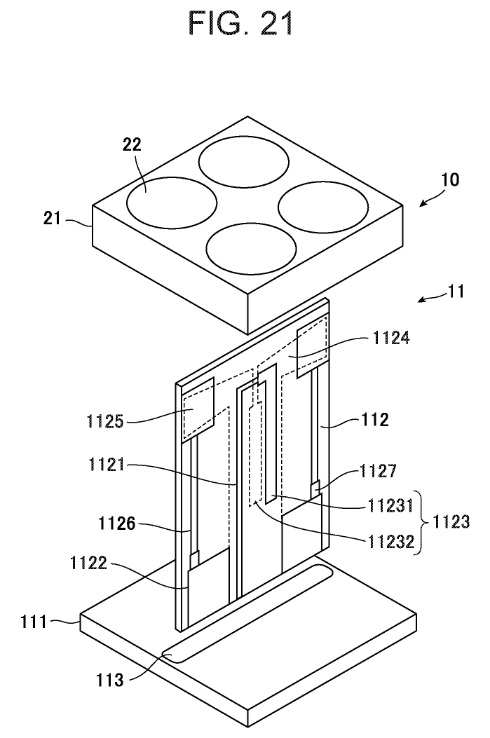

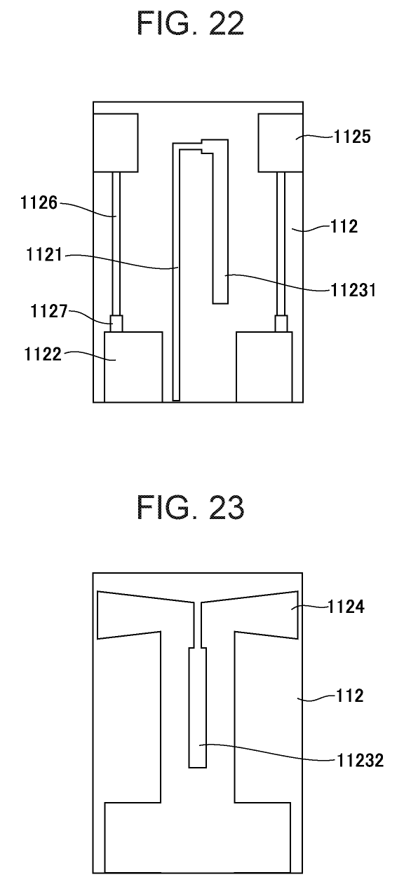

FIG. 20 is a perspective view illustrating a configuration example of a unit cell 10 in an antenna device according to a fourth embodiment. FIG. 21 is an exploded perspective view illustrating a configuration example of the unit cell 10 in the antenna device according to the fourth embodiment. In addition, FIG. 22 is a side view illustrating a configuration example of a first layer of a dielectric substrate 112 in the fourth embodiment, and FIG. 23 is a side view illustrating a configuration example of a second layer of the dielectric substrate 112 in the fourth embodiment.

The antenna device according to the fourth embodiment is obtained by interposing a resistor 1127 in a short-circuit conductor pattern 1126 in the antenna device according to the third embodiment. Other configuration examples of the antenna device according to the fourth embodiment are similar to the configuration examples of the antenna device according to the third embodiment, the same reference signs are given to them, and explanation thereof is omitted.

The resistor 1127 is provided on a first surface of the dielectric substrate 112. The resistor 1127 is interposed in the short-circuit conductor pattern 1126.

In the antenna device illustrated in FIGS. 20 to 23, the resistor 1127 is provided at a second end of the short-circuit conductor pattern 1126. That is, in the antenna device illustrated in FIGS. 20 to 23, a first end of the resistor 1127 is connected to the second end of the short-circuit conductor pattern 1126, and a second end of the resistor 1127 is connected to a ground 1122.

Next, advantageous effects of the antenna device according to the fourth embodiment are explained.

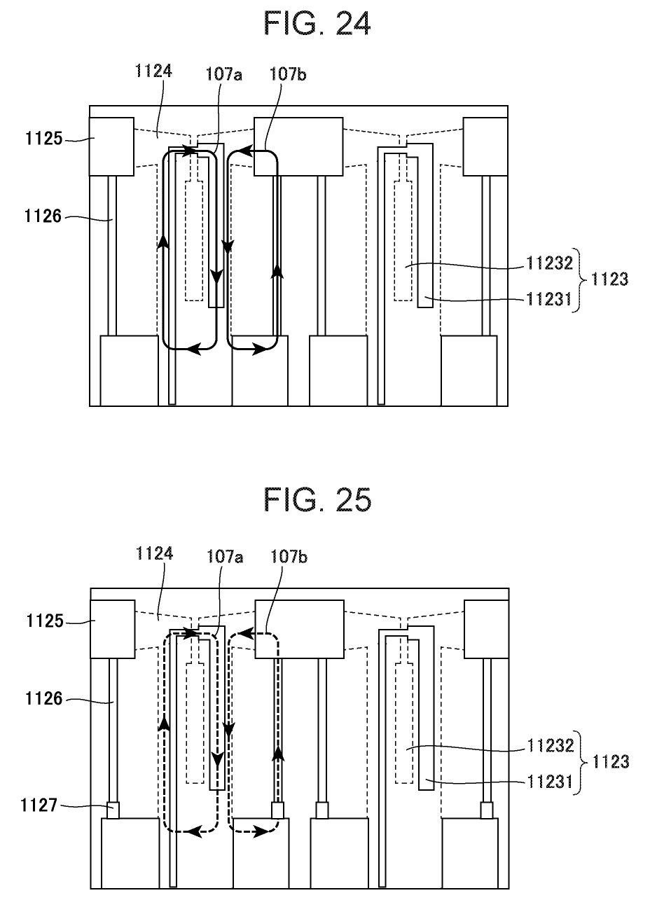

FIG. 24 is a side view illustrating an example of current distribution in a case where the resistor 1127 is not provided on the dielectric substrate 112. FIG. 25 is a side view illustrating an example of current distribution in a case where the resistor 1127 is provided on the dielectric substrate 112.

As illustrated in FIG. 24, when a coupling conductor pattern 1125 and the ground 1122 are connected using the short-circuit conductor pattern 1126, a loop current 107a flowing through a balun 1123 and a loop current 107b flowing through the short-circuit conductor pattern 1126 are formed. In this case, the one loop current 107a excites the other loop current 107b, and the loop current 107b resonates. As a result, the antenna characteristics of the antenna device deteriorate.

In view of this, in the antenna device according to the fourth embodiment, the resistor 1127 is interposed in the short-circuit conductor pattern 1126. Thereby, as illustrated in FIG. 25 for example, the loop current 107b flowing through the short-circuit conductor pattern 1126 is attenuated, and it is possible to reduce the influence of the loop resonance.

As described above, according to the fourth embodiment, the resistor 1127 is interposed in the short-circuit conductor pattern 1126. Thereby, the influence of the loop resonance are reduced, and it is possible to further broaden the bandwidth of the antenna device according to the fourth embodiment, in addition to the advantageous effects of the third embodiment.

Fifth Embodiment.

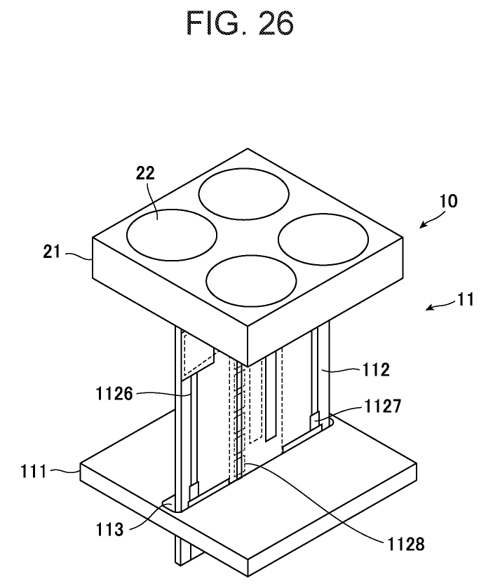

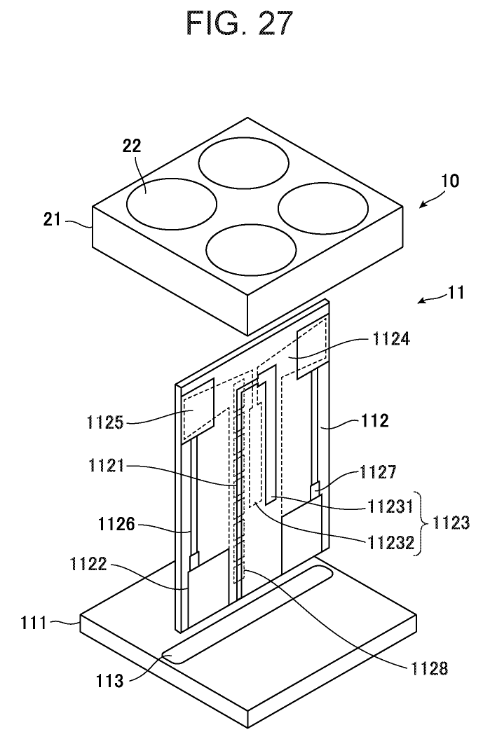

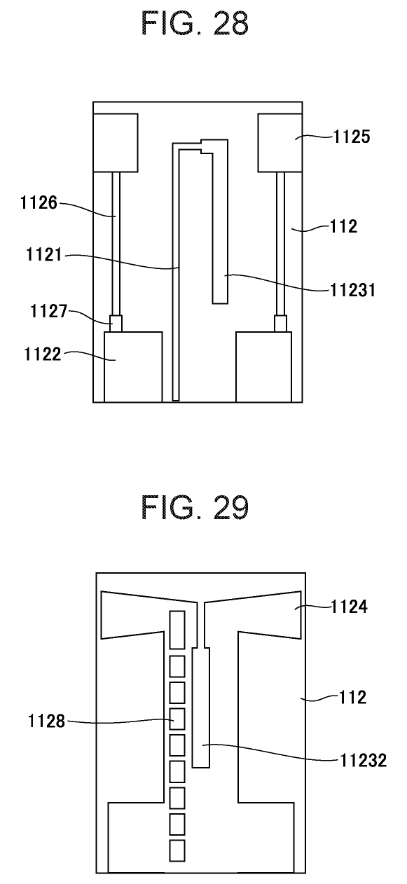

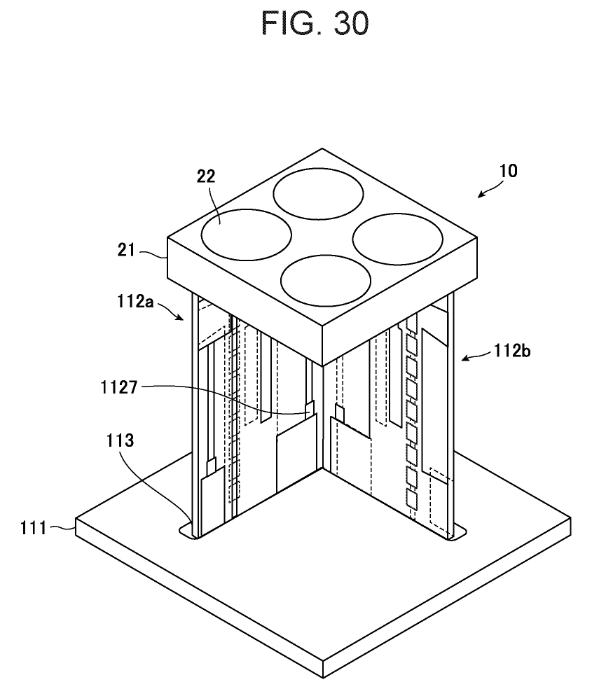

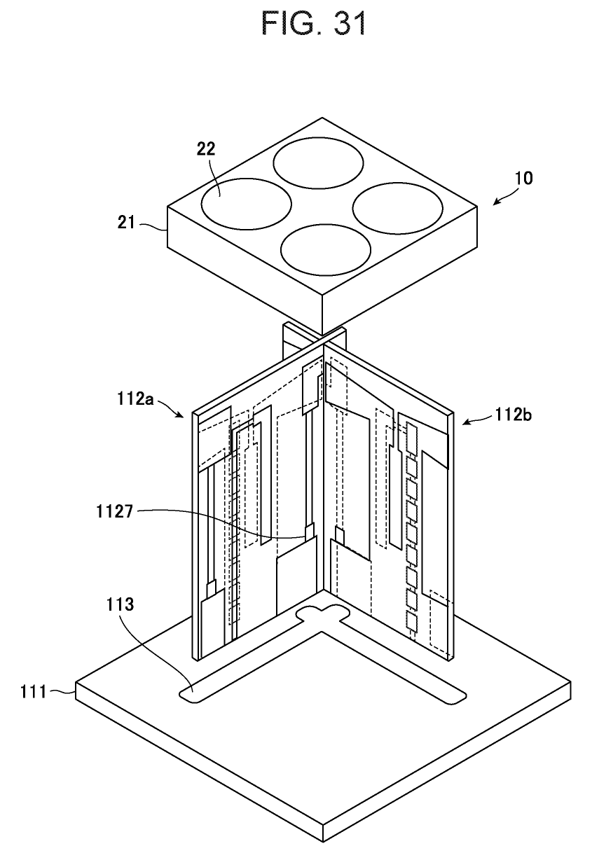

FIG. 26 is a perspective view illustrating a configuration example of a unit cell 10 in an antenna device according to a fifth embodiment. FIG. 27 is an exploded perspective view illustrating a configuration example of the unit cell 10 in the antenna device according to the fifth embodiment. In addition, FIG. 28 is a side view illustrating a configuration example of a first layer of a dielectric substrate 112 in the fifth embodiment, and FIG. 29 is a side view illustrating a configuration example of a second layer of the dielectric substrate 112 in the fifth embodiment.

The antenna device according to the fifth embodiment is obtained by providing a plurality of holes 1128 to a ground of a feed line 1121 in the antenna device according to the fourth embodiment. Other configuration examples of the antenna device according to the fifth embodiment are similar to the configuration examples of the antenna device according to the fourth embodiment, the same reference signs are given to them, and explanation thereof is omitted.

The plurality of holes 1128 are provided through the ground of the feed line 1121 on a second surface of the dielectric substrate 112.

Next, advantageous effects of the antenna device according to the fifth embodiment are explained.

In a representative feed line such as a microstrip line, a strip line, or a coplanar line, which is an unbalanced line, typically, the characteristic impedance rises as the spacing between the signal line and the ground is increased. Because of this, by providing holes through the ground of the signal line, the spacing between the signal line and the ground is increased, and the characteristic impedance of the feed line can be caused to rise. On the other hand, it is known that, in this case, the input impedance of a tightly coupled dipole coupled to an adjacent dipole is approximately 200 Ω.

In view of this, in the antenna device according to the fifth embodiment, the feed line 1121 provided with the plurality of holes 1128 at the ground is used. Thereby, it is possible to excite a dipole 1124 using the feed line 1121 with a characteristic impedance close to the input impedance of the tightly coupled dipole, that is, the feed line 1121 with a high characteristic impedance. As a result, the antenna device according to the fifth embodiment can be configured as a broader-bandwidth antenna.

As described above, according to the fifth embodiment, the dielectric substrate 112 has, on a first surface, the feed line 1121 that supplies a high-frequency signal for exciting the dipole 1124, and the feed line 1121 is provided with the plurality of holes 1128 at the ground. Thereby, it is possible to further broaden the bandwidth of the antenna device according to the fifth embodiment, in addition to the advantageous effects of the fourth embodiment.

Sixth Embodiment.

FIG. 30 is a perspective view illustrating a configuration example of a unit cell 10 in an antenna device according to a sixth embodiment. FIG. 31 is an exploded perspective view illustrating a configuration example of the unit cell 10 in the antenna device according to the sixth embodiment.

The antenna device according to the sixth embodiment is obtained by providing, as a dielectric substrate 112, a horizontal polarization element (first dielectric substrate) 112a and a vertical polarization element (second dielectric substrate) 112b in the antenna device according to the fifth embodiment. Other configuration examples of the antenna device according to the sixth embodiment are similar to the configuration examples of the antenna device according to the fifth embodiment, the same reference signs are given to them, and explanation thereof is omitted.

Note that a slot 113 having two sides is formed in a metallic plate 111 in the fifth embodiment. In FIG. 30, one side of the slot 113 is formed along an element array axis 101a, and the other side of the slot 113 is formed along an element array axis 101b.

The horizontal polarization element 112a is a substrate for emitting radio waves in the horizontal direction. In FIG. 30, the horizontal polarization element 112a is disposed along the element array axis 101b.

The vertical polarization element 112b is a substrate that is disposed to be orthogonal (including substantially orthogonal) to the horizontal polarization element 112a, and is for emitting radio waves in the vertical direction. In FIG. 30, the vertical polarization element 112b is disposed along the element array axis 101a.

Each of the horizontal polarization element 112a and the vertical polarization element 112b is configured similarly to the dielectric substrate 112 in the fifth embodiment.

By adopting such a configuration, the antenna device according to the sixth embodiment can emit radio waves of dual orthogonal polarization, in addition to the advantageous effects of the fifth embodiment.

Next, advantageous effects of the antenna device according to the sixth embodiment are explained.

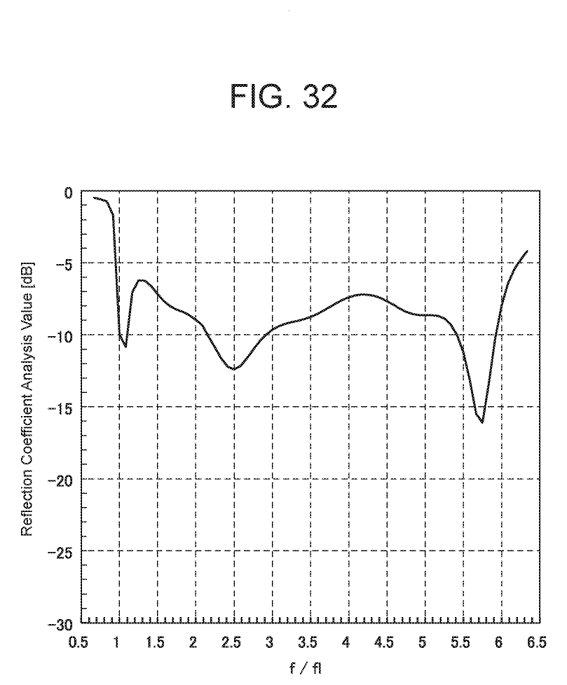

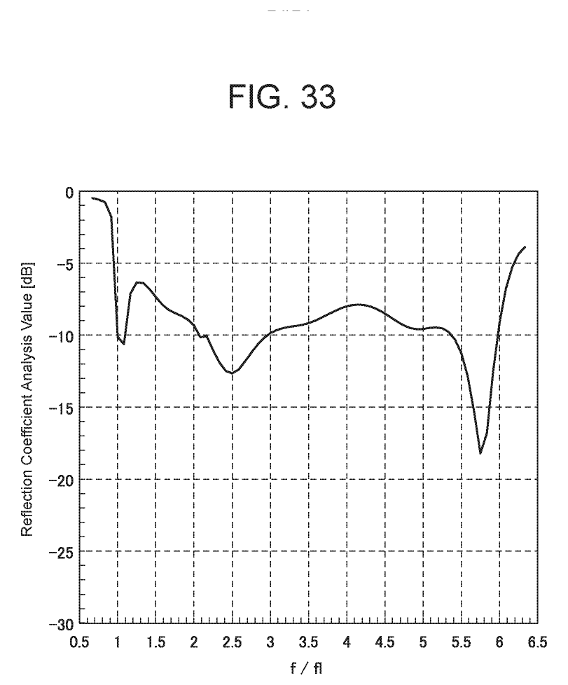

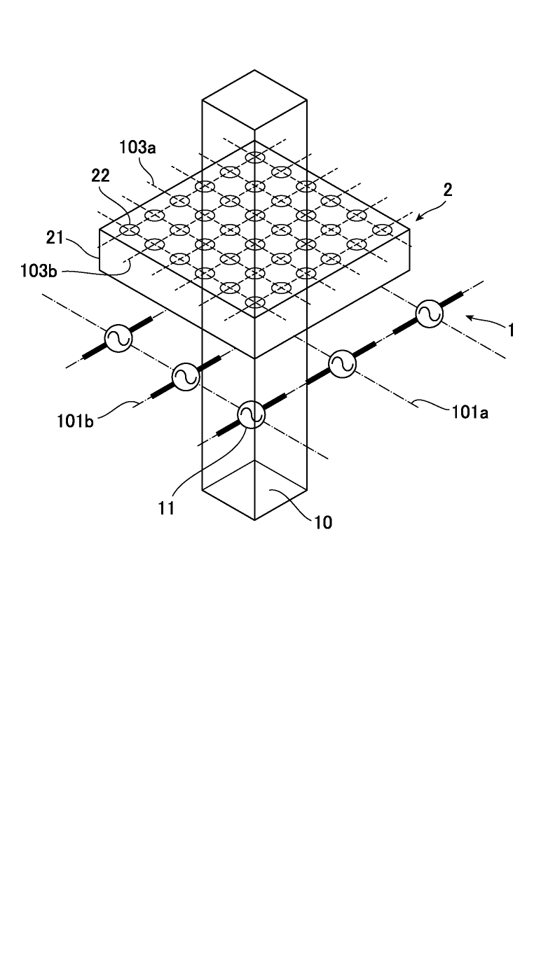

FIG. 32 is a drawing illustrating an example of a reflection coefficient analysis value (electromagnetic field analysis result) of the horizontal polarization element 112a. FIG. 33 is a drawing illustrating an example of a reflection coefficient analysis value (electromagnetic field analysis result) of the vertical polarization element 112b. Note that, in each of FIG. 32 and FIG. 33, the horizontal axis and the vertical axis represent the frequency normalized by a low frequency fl and the reflection coefficient analysis value, respectively.

FIG. 32 and FIG. 33 illustrate that the horizontal polarization element 112a and the vertical polarization element 112b do not exhibit unnecessary resonance, and reflectance characteristics with a bandwidth which is equal to or greater than six times (reflection coefficient ≤ -6 dB) are obtained, thereby confirming the effectiveness of the sixth embodiment.

Note that, in the illustrated case, the horizontal polarization element 112a and the vertical polarization element 112b are used as the dielectric substrate 112 in the antenna device according to the fifth embodiment. However, this is not the sole example. The horizontal polarization element 112a and the vertical polarization element 112b may be used as the dielectric substrate 112 in the antenna device according to the third embodiment or the antenna device according to the fourth embodiment, and advantageous effects similar to those described above can be achieved.

As described above, according to the sixth embodiment, the dielectric substrate 112 is the horizontal polarization element 112a and the vertical polarization element 112b that are arranged to be mutually orthogonal. Thereby, the antenna device according to the sixth embodiment can emit radio waves of dual orthogonal polarization, in addition to the advantageous effects of the third to fifth embodiments.

Note that any combination of the respective embodiments, modification of any components in the respective embodiments, and omission of any components in the respective embodiments is possible.

### INDUSTRIAL APPLICABILITY

It is possible to broaden the bandwidth of the antenna device according to the present disclosure at low cost compared to conventional techniques, and the antenna device is suited for being used as an antenna device including an array antenna and the like.

### REFERENCE SIGNS LIST

1: Array antenna; 2: Matching layer; 10: Unit cell; 11: Element antenna; 21: Dielectric; 22: Hole; 111: Metallic plate; 112: Dielectric substrate; 112a: Horizontal polarization element (first dielectric substrate); 112b: Vertical polarization element (second dielectric substrate); 113: Slot; 1121: Feed line; 1122: Ground; 1123: Balun; 1124: Dipole; 1125: Coupling conductor pattern; 1126: Short-circuit conductor pattern; 1127: Resistor; 1128: Hole; 11231: Open stub; 11232: Short stub

1. An antenna device comprising:
an array antenna having element antennas regularly arrayed at first spacing along first array axes; and
a dielectric that has holes arrayed at second spacing which is 1/n (n is an integer equal to or greater than two) of the first spacing along second array axes lying in the same direction as the first array axes, the dielectric being disposed to face the array antenna in a direction orthogonal to the first array axes.

2. The antenna device according to claim 1, wherein
the element antennas include:
a metallic plate disposed along the first array axes; and
a dielectric substrate that: has a dipole which is a metallic conductor on a first surface; is inserted into the metallic plate; and is disposed in a direction orthogonal to the first array axes.

3. The antenna device according to claim 2, wherein
the dielectric substrate has a coupling conductor pattern which is a metallic conductor at a position which is on a second surface and overlaps two adjacent dipoles.

4. The antenna device according to claim 3, wherein
the dielectric substrate has, on the second surface, a short-circuit conductor pattern which is a metallic conductor having a first end connected to the coupling conductor pattern and a second end connected to a ground.

5. The antenna device according to claim 4, wherein
a resistor is interposed in the short-circuit conductor pattern.

6. The antenna device according to claim 5, wherein
the dielectric substrate has, on the first surface, a feed line to supply a high-frequency signal for exciting the dipole, and
the feed line is provided with a plurality of holes at a ground.

7. The antenna device according to claim 4, wherein
the dielectric substrate is a first dielectric substrate and a second dielectric substrate that are arranged to be mutually orthogonal.

8. The antenna device according to claim 5, wherein
the dielectric substrate is a first dielectric substrate and a second dielectric substrate that are arranged to be mutually orthogonal.

9. The antenna device according to claim 6, wherein
the dielectric substrate is a first dielectric substrate and a second dielectric substrate that are arranged to be mutually orthogonal.
